(19) United States
(12) Patent Application Publication
(10) Pub. No.: US 2023/0297956 A1
(43) Pub. Date: Sep. 21, 2023

(54) SYSTEM AND METHOD FOR MANAGING INVOICE EXCEPTIONS

(71) Applicant: Genpact Luxembourg S.à r.l. II, Luxembourg (LU)

(72) Inventors: Niloo Kumari, Bangalore (IN); Sayantan Banerjee, Kolkata (IN); Anirudh Sharma, New Delhi (IN); Ravi Kumar, Bangalore (IN); David I. Hauser, Merrick, NY (US); Sreekanth Menon, Bangalore (IN); Bhavani Eshwar, Bangalore (IN); Bindu Manoj, Alpharetta, GA (US); Nikhil Deshpande, Bentonville, AR (US); Anurag Thakor, Plano, TX (US); Amit Kapur, McKinney, TX (US)

(21) Appl. No.: 17/699,654

(22) Filed: Mar. 21, 2022

(51) Int. Cl. G06Q 10/08; G06V 30/412; G06V 30/19; G06V 30/32

(52) U.S. Cl. CPC G06Q 10/0875; G06V 30/412; G06V 30/19093; G06V 30/387; G06N 20/00

(57) ABSTRACT

A method and system for detecting deviation between invoices and receipts are disclosed. In some embodiments, the method includes receiving invoice data and receipt data. The method includes filtering the received data to generate filtered data. The method includes performing line-level matching on the filtered data based on one or more line-level attributes and one or more distance based algorithms. The method then includes determining, from the line-level matching, matched line items and unmatched line items between each pair of the invoice and receipts. The method also includes calculating one or more types of claims for both the matched line items and the unmatched line items to measure a total deviation between the invoices and receipts. The method further includes determining a level of match between the invoices and receipts and generating a recommended matching pair of invoice and receipt based on the level of match. The matches are further improved by user feedback to the recommended pairs which is used to train a machine learning model.

### TECHNICAL FIELD

This disclosure relates to a method and system for determining a deviation between an invoice and a receipt based on line-level matching and claim calculation using distance based algorithms followed by machine learning (ML) modeling for retraining weights from user feedback data.

### BACKGROUND

Invoice management digitalizes and automates account payable processes. Rather than processing only invoices, invoice management includes streamlining the invoices with respect to order/delivery information. This is based on communications between multiple parties such as vendors/manufacturers producing the invoice data and retailers/customers generating order and/or recipient data. However, the multi-party communications may make some invoice management tasks very challenging. A well-developed business may generate a large number of invoices through daily operations, which may further worsen the implementation of some essential invoice management tasks, and significantly influence the goal of enhancing control and speeding invoice processing and workflows.

One of the essential invoice management tasks is to match an invoice to a receipt before making a payment. When there is a tremendous amount of data and/or the data is incomplete, incorrect, or product description is abbreviated, it is often difficult to match an invoice to a receipt. Even if there is a match, the match may be false and thus cause a false claim and/or dispute. Many existing matching approaches are error-prone and tend to generate a high degree of manual claims and disputes. Therefore, the matching algorithms do not only lack accuracy and efficiency but also inflate additional operation overheads.

### SUMMARY

To address the aforementioned shortcomings, a method and a system for detecting deviation between invoices and receipts are provided. The method receives data of the invoices and receipts. The method filters the received invoice and receipt data to generate filtered data. The method performs line-level matching on the filtered data based on one or more line-level attributes and one or more distance-based algorithms to identify line item matches between the invoices and receipts. The method determines, from the line-level matching, one or more matched line items and unmatched line items between each pair of the invoices and receipts included in the filtered data. The method then calculates one or more types of claims for both the matched line items and the unmatched line items to measure a total deviation between each pair of the invoices and receipts. The method further determines a level of match between each pair of the invoices and receipts based on the calculated claims and generates a recommended matching pair of invoice and receipt based on the level of match between each pair of the invoices and receipts.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a system architecture for managing invoice exceptions, according to embodiments of the disclosure.

FIG. 2 illustrates an exemplary high-level process for detecting and managing invoice exceptions, according to embodiments of the disclosure.

FIG. 3 is a server used as part of a system for detecting and managing invoice exceptions using the methods described herein, according to embodiments of the disclosure.

FIG. 4 are example tables illustrating line-level matching of invoice and receipt, according to embodiments of the disclosure.

FIG. 5 is an example process for calculating claims responsive to line-level matching performed as shown in FIG. 4, according to embodiments of the disclosure.

FIG. 6 illustrates a flowchart of detecting and managing deviation between an invoice and a receipt, according to embodiments of the disclosure.

FIG. 7 illustrates a flowchart of creating binding from invoice and receipt data, according to embodiments of the disclosure.

FIG. 8 illustrates a flowchart of line-level matching between invoice and receipt data, according to embodiments of the disclosure.

### DETAILED DESCRIPTION

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The present disclosure provides a system and method for resolving invoice exceptions. An invoice is an exception when a matching receipt associated with the invoice cannot be found. Using various distance metrics such as Levenshtein and Jaro-Winkler, the present disclosure may capture the discrepancies in the product line description. In some embodiments, the present disclosure may perform multiple customized calculations to determine the deviation between a given invoice product line and a receipt product line, and aggregate the deviation at a total invoice level and/or total receipt level. The present disclosure may quantify the deviation between an invoice and a receipt based on the mismatches in the product line description, price, and/or quantity. The present disclosure may generate and provide a match result to a customer/user. The match result may include a recommendation of the best match (e.g., a match with a highest match percentage) based on the normalized value of absolute quantified deviation. In some embodiments, the present disclosure may also detect and determine a match when there is a one-to-many relationship or many-to-many relationship between invoices and receipts. The one-to-many relationship reflects a single invoice item/invoice that may correspond to multiple receipt items/receipts, and vice versa. This relationship may be both at a line level and at an overall level. The present disclosure may further use a feedback loop model in algorithm/model retraining to increase the accuracy and relevancy over time.

Although the present disclosure mainly focuses on match identification between invoices and receipts, one skilled in the art should recognize that the approach described herein may also be applied to other identifications between other types of data when those data include similar characteristics such as line item determination, one-to-many relationships, etc.

A typical transaction between a retailer/customer and a vendor/manufacturer may be summarized as below:
1. The retailer, who wishes to maintain an inventory, places a purchase order (PO) with the vendor, either electronically or on paper.
2. Upon receiving the PO, the vendor fulfills the order either fully or partially (e.g., depending on the availability of goods) and delivers the goods to a desired location.
3. When the goods are received, the retailer generates a receipt. Meanwhile, the vendor sends an invoice to the retailer.
4. A party (e.g., retailer's account payable department, third party) then determines whether the goods included in the PO have been received and whether the same is reflected in the invoice as well.
5a. If the invoice exactly matches the receipt, the party makes a payment to the vendor; or
5b. If the invoice does not exactly match the receipt, the party will then need to find the correct matching receipts, raise a claim, or dispute the invoice.

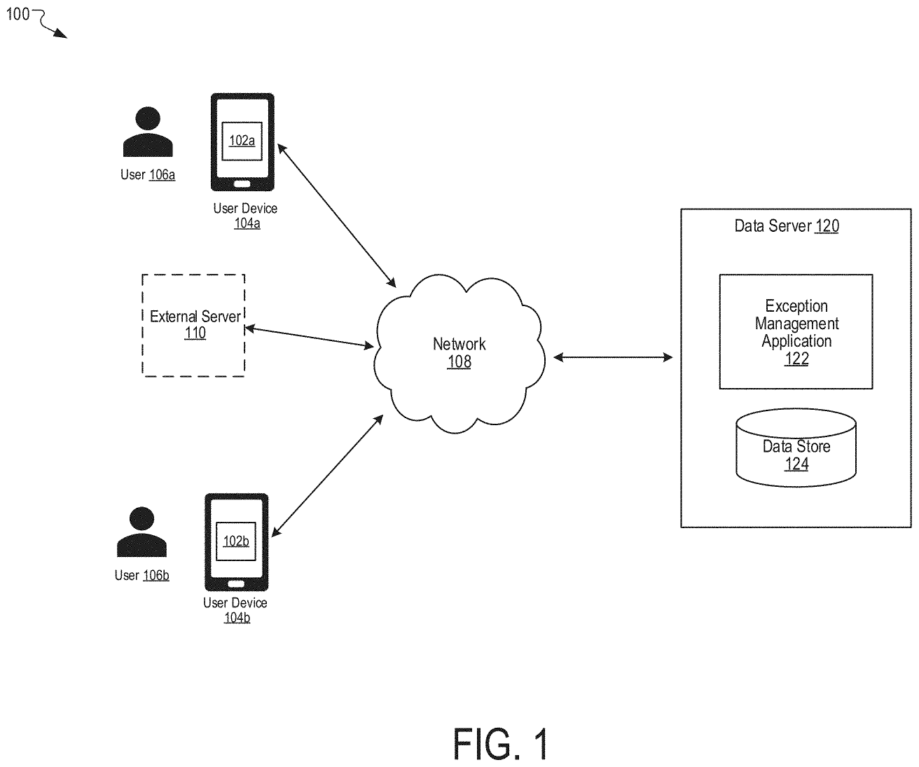

In the above 5b, an invoice exception (or simply “exception”) occurs, that is, when no clear match exists between an invoice record and receipt record. In some embodiments, the invoice exception may also be defined if the PO on the incoming invoice does not match an existing PO. An invoice exception may be caused for different reasons: for example, the data volume is too large (e.g., with limited processing power), the retailer has multiple stores and is dealing with multiple vendors (e.g., thereby easily confusing vendor and/or retailer information), or there are data entry errors, short names for item description, typos or missing data, etc. Specifically, the exception may be reflected in wrong order amount (quantity deviation), price deviation, line deviation, wrong reference or purchase order (e.g., mismatch of vendor), duplication processing, etc. The detection and management of invoice exception will be described in detail with reference to FIGS. 1-8.

Across a vast majority of industries, the inability to match the right receipt to the right invoice may lead to operational overheads and revenue leakage because of the lack of visibility to the right inventory. The operational overhead may include additional network and computer resource usage, extra processing time, extra processing power, enhanced hardware/software requirements, etc. Advantageously, the present disclosure describes an improved algorithm based on identifying appropriate attributes and calculating distances between the identified attributes to match the invoices and receipts, which significantly increases the matching percentage (e.g., reducing the exceptions) and thus greatly reduces the operational overheads otherwise used to handle the exceptions.

The existing matching approaches often obtain incorrect matching of invoices and receipts, which leads to the generation of false claims and disputes that impact various performance metrics. Rather than matching summaries of invoices and receipts by using the existing approaches, the present disclosure builds an algorithm that matches an invoice to receipt at both header and line levels. Advantageously, the false matching rate is reduced and, correspondingly, the number of false claims and disputes is reduced. The present disclosure may flag a problem or even a claim, but that claim would not be a false claim. Therefore, the problem/claim identification as described herein improves the matching performance.

When an exception happens, usually a manual exception handling process is initiated. By minimizing the occurrence of exceptions, the present disclosure significantly reduces the requirement for human intervention and improves system automation. Also, the present disclosure significantly reduces the computer and network resource usage in the sense that it minimizes the impact of the time-consuming and costly manual exception handling process.

Advantageously, the present disclosure may accurately match the invoices and receipts when a single receipt may consist of multiple invoices of multiple product lines or a single invoice may relate to multiple receipt transactions. In contrast, the existing matching approaches are unable to detect and process such a one-to-many relationship or a many-to-many relationship between invoices and recipients, either in an overall level (e.g., one invoice being associated with multiple receipts) or in a line level (e.g., one line of an invoice being associated with multiple lines of a receipt).

Furthermore, the present disclosure accommodates a feedback loop mechanism that improves the accuracy, reliability, and flexibility of the system over time. Other advantageous aspects of the present disclosure will also be described below in view of the system architecture for managing invoice exceptions as shown in FIG. 1.

### Overall Exception Management Workflow

Systems and methods for providing advanced invoice management by a data server are described below. This advanced invoice management systems and methods provide a technical solution to an issue rooted in technology, including improved systems and methods for processing and analyzing disparate data (e.g., invoice data, receipt data) in large volumes at scale from multiple sources (e.g., vendors, customers, or third parties). The disclosed approach may also be used for expedited invoice processing based on various factors such as improved identification of one-to-many relationships, reduced false match rate, etc.

The data server may unconventionally utilize data from various sources (e.g., vendors, retailers, third parties) to provide an analytical information-based platform for managing invoices. For example, the data server may analyze rich data from different sources, identify correlating and corresponding relationships that may be helpful to the performance improvement such as increasing the match percentage between the invoices and receipts, reducing false claims, etc.

The data server may include artificial intelligence (AI) or machine learning (ML) modules and systems for identifying relationships relating to invoices and receipts and for making decisions relating to invoice management. The AI/ML modules and systems in the data server may analyze data from vendors, retailer/customers and/or third-party platforms. Such analysis of invoice and receipt data may include analyzing summary information of historical invoices and/or receipts such as invoice amount, receipt amount, invoice date, receipt date, etc. More importantly, the analysis is also based on line-level information of historical invoices and/or receipts such as item number, item description, item quantity, item price, etc. The AI/ML modules and systems may include logic for generating scores as to a particular invoice and/or a particular item of the particular invoice, and presenting the scores and other information to a customer through a customized and dynamic user interface. The data server may use the AI/ML modules and systems for automatically identifying the discrepancy between the tremendous amount of invoices and receipts and providing and updating a recommendation.

FIG. 1 is a system 100 for managing invoice exceptions, according to embodiments of the disclosure. Each of user devices 104a and 104b may be respectively utilized by user 106a and 106b (e.g., vendor and retailer) to perform invoice-management-related tasks via the respective software applications 102a and 102b. For simplicity and clarity, these numerical references may also be collectively referred to as 104, 106, and 102. By way of example and not limitation, user device 104 may be a smartphone device, a tablet, a tablet personal computer (PC), or a laptop PC. In some embodiments, user device 104 may be any suitable electronic device connected to a network 108 via a wired or wireless connection and capable of running software applications like software application 102. In some embodiments, user device 104 may be a desktop PC running software application 102. In some embodiments, software application 102 may be installed on user device 104 or be a web-based application running on user device 104. By way of example and not limitation, user 106 may be a person that intends to identify a matching receipt and/or invoice, make a payment based on the matching, etc. The user may communicate with data server 120 via software application 102 residing on user device 104.

Network 108 may be an intranet network, an extranet network, a public network, or combinations thereof used by software application 102 to exchange information with one or more remote or local servers, such as data server 120, external server 110. According to some embodiments, software application 102 may be configured to exchange information, via network 108, with additional servers that belong to system 100 or other systems similar to system 100 not shown in FIG. 1 for simplicity.

External server 110 may be a third party that receives invoices and/or receipts based on a vendor-retailer relationship. For example, a retailer/customer may place a purchase order (PO), and a vendor/manufacturer may provide goods included in the PO to the customer. The vendor may generate an invoice through the third party or external server 110, and external server 110 may track the invoice through payment from the customer. In some embodiments, the invoice-related data may be directly transferred from external server 110 to data server 120.

In some embodiments, external server 110 is configured to initially determine whether an invoice has a matching receipt before making a payment. Usually, invoices and receipts have some common identifiers (IDs) that are useful for data matching. When a retailer generates a PO, the PO often includes information such as PO ID/PO number, item number, item description, price, quantity, store number, vendor number, or the like. When the vendor sends an invoice to the retailer, the invoice would likely contain at least a subset of the PO information along with the added invoice information such as an invoice number. For example, the invoice number may be set to be the same as the PO ID to simplify and facilitate the match between the invoice and the receipt. Therefore, external server 110 may be able to apply a filter based on one or more common variables (e.g., vendor number, store number, or invoice number) to identify a match between the invoice data and receipt data. If each common variable of the items in the invoice and receipt data matches, there is an exact match and no claim is generated. If there is a mismatch in price, quantity, or item description, then a respective claim is generated. If an invoice does not have any matching receipt, then an exception happens, which causes a lot of claims and disputes to be generated. However, the existing matching algorithms used by external server 110 are often problematic in generating unnecessary false claims or exceptions, especially when the data volume is large and/or a one-to-many relationship exists.

In some embodiments, external server 110 may perform a first level or initial determination about whether an invoice has a matching receipt before making a payment, and data server 120 may perform a second level or final determination about the data match and generation of invoice exceptions based on the initial determination received from external server 110. In other embodiments, external server 110 may be substituted by data server 120, where data server 120 directly communicates with user 106 to perform the data matching and exception management functionality as described herein.

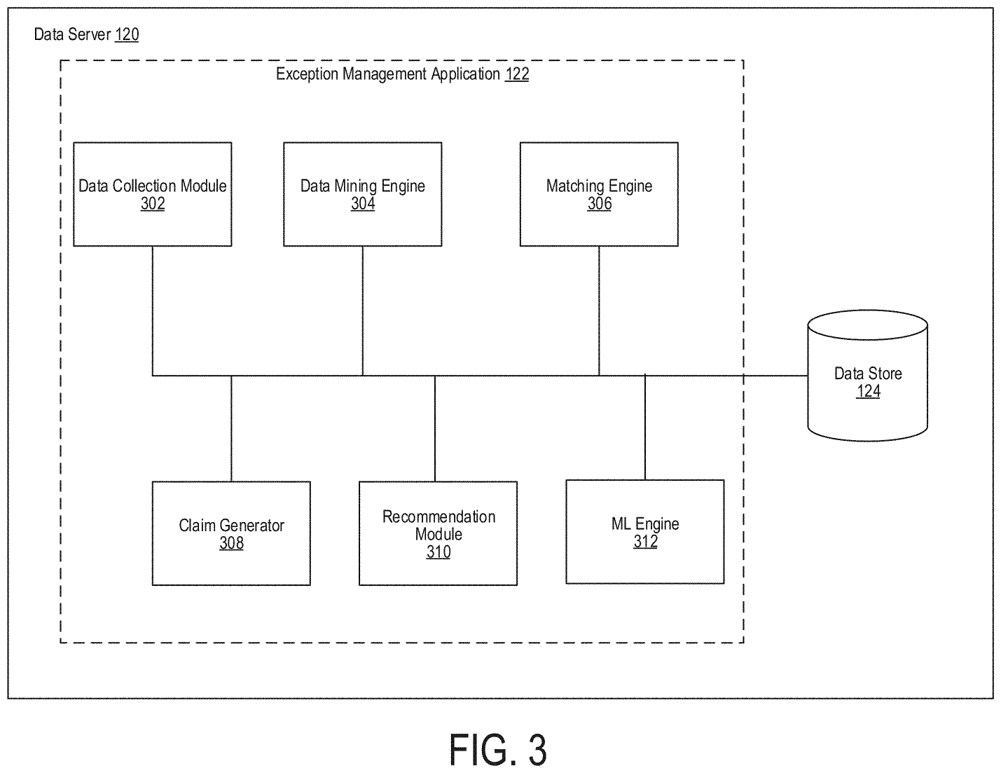

Data server 120 is configured to store, process, and analyze the received invoice and receipt data to identify matching recipient(s) associated with an invoice and manage any possible invoice exceptions. In some embodiments, data server 120 receives the data from user 106, via software application 102, and subsequently transmits in real-time processed data back to software application 102. In other embodiments, data server 120 receives the data from external server 110 for further processing. In the illustrated embodiment, data server 120 includes an exception management application 122 and a data store 124, which each includes a number of modules and components discussed below with reference to FIG. 3. In some embodiments, data server 120 may be a cloud-based server.

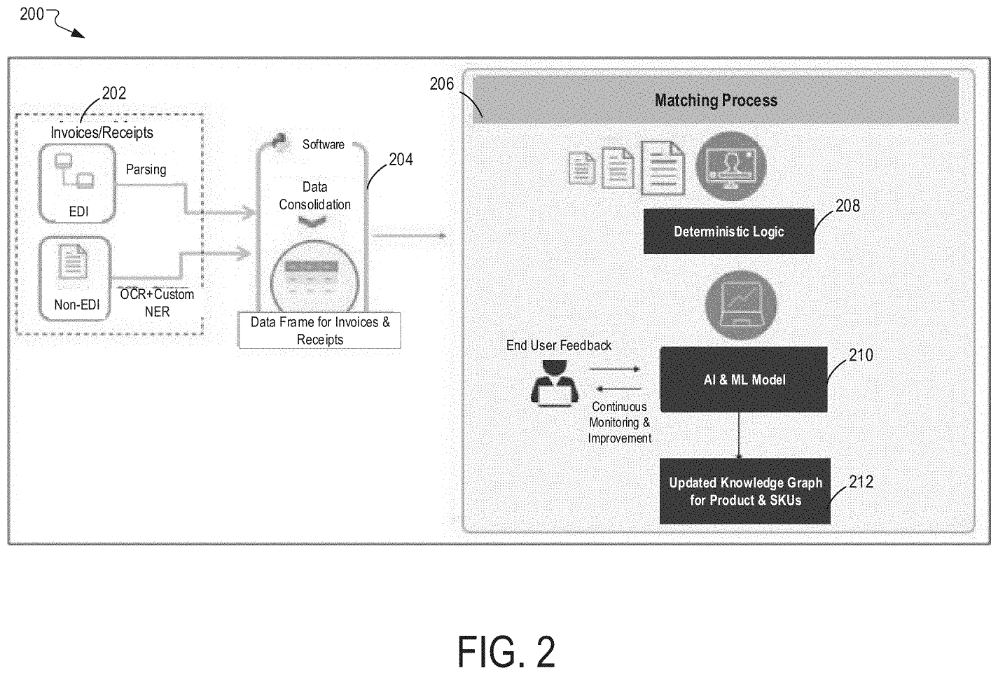

FIG. 2 illustrates an exemplary high-level process 200 for detecting and managing invoice exceptions, according to embodiments of the disclosure. The process starts with operation 202, where invoice and recipient data are received and pre-processed. Depending on whether the received data is electronic data interchange (EDI) data or non-EDI data, it is processed differently, e.g., either be parsed or be analyzed using optical character recognition (OCR) and custom name entity recognition (NER). At operation 204, the pre-processed data is consolidated (e.g., categorized in groups) in a data framework using software tools such as Python. The processed data is then moved for implementing a matching process at operation 206.

In some embodiments, deterministic logic 208 is used in the matching process to determine whether an invoice has a matching receipt and generate and provide an output (e.g., including match recommendation and/or claims) based on the matching determination. Deterministic logic 208 may use one or more artificial intelligence (AI) and machine learning (ML) models 210 to determine the match/mismatch between the invoice and receipt data. Once a match/mismatch determination is made, user feedback is collected and fed into the model(s) to retrain the model(s) to enhance the match determination. The continuous monitoring of the match determinations/output and collection of user feedback, therefore, improve the matching determination over time and the invoice management performance. In some embodiments, a knowledge graph is also updated based on the training and retraining of the model(s) to further improve the performance of invoice management. The process of FIG. 2 will be described in detail with reference to FIGS. 3-8 below.

### Invoice Exception Detection and Management

In some embodiments, FIG. 3 depicts selective components of data server 120 used to perform the functionalities described herein, for example, operations of process 200. Data server 120 may include additional components not shown in FIG. 3. These additional components are omitted merely for simplicity. These additional components may include, but are not limited to, computer processing units (CPUs), graphical processing units (GPUs), memory banks, graphic adaptors, external ports and connections, peripherals, power supplies, etc., required for the operation of data server 120. The aforementioned additional components, and other components, required for the operation of data server 120 are within the spirit and the scope of this disclosure.

In the illustrated embodiment of FIG. 3, data server 120 includes an exception management application 122 and a data store 124. Exception management application 122 in turn includes one or more modules responsible for processing and analyzing the information received by data server 120. For example, the modules in exception management application 122 may have access to the invoice and receipt data associated with vendor(s) and retailer(s), and generate a match result including one or more of a match recommendation, a claim, etc.

In some embodiments, each module of exception management application 122 may store the data used and generated in performing the functionalities described herein in data store 124. Data store 124 may be categorized in different libraries (not shown). Each library stores one or more types of data used in implementing the methods described herein. By way of example and not limitation, each library may be a hard disk drive (HDD), a solid-state drive (SSD), a memory bank, or another suitable storage medium to which other components of data server 120 have read and write access.

In some embodiments, exception management application 122 of data server 120 includes a data collection module 302, a data mining engine 304, a matching engine 306, a claim generator 308, a recommendation module 310, and an ML engine 312. In some embodiments, exception management application 122 of data server 120 may include only a subset of the aforementioned modules or include at least one of the aforementioned modules. Additional modules may be present on other servers communicatively coupled to data server 120. For example, data collection module 302 and data mining engine 304 may be deployed on separate servers (including data server 120) that are communicatively coupled to each other. All possible permutations and combinations, including the ones described above, are within the spirit and the scope of this disclosure.

### Pre-Processing Data

Data collection module 302 receives and pre-processes the invoice and receipt data. In some embodiments, data collection module 302 may receive the invoices from vendor(s) and receive the receipts from retailer(s). In other embodiments, data collection module 302 may communicate with another party (e.g., external server 110 that handles the initial invoice and/or receipt processing) to receive the invoice and receipt data.

In some embodiments, data collection module 302 in combination with a user interface engine (not shown) generates and provides an interface to one or more of a vendor, a retailer, or a third party. Each of the vendor, the retailer, or the third party interacts with data collection module 302 to cause data collection module 302 to receive the invoice and receipt data. As the processing of the invoice and receipt data proceeds, data collection module 302 and/or other components of server 120 may update the interface or generate new interface(s) to dynamically reflect the data processing progress.

Data collection module 302 receives the invoice and receipt data in two different formats: EDI and non-EDI. If the received data is in a structured and standard EDI format, data collection module 302 may parse and prepare the data. However, if the received data is in a non-EDI format, data collection module 302 may analyze the data through OCR and NER to generate data required for subsequent processing. For example, if the received data are in the form of images, data collection module 302 may scan the received invoices and receipts by advanced OCR to convert the scanned images into text information. Data collection module 302 may then cluster the converted text, for example, based on format similarities. Once the invoices are clustered in terms of similarities, data collection module 302 may train different custom name entity recognition models for different clusters to determine the key elements of the received data. For example, an invoice's key elements may include product description, price, quantity, etc. Once the received data is converted into structured data and/or key elements are determined, the pre-processing is complete. Data collection module 302 may transmit the pre-processed data to data mining engine 304 for further processing. In some embodiments, data collection module 302 may also store the pre-processed data in data store 124.

### Creating Bindings

Data mining engine 304 receives the pre-processed data and creates one or more bindings. In some embodiments, data mining engine 304 may sort and divide the pre-processed invoice and receipt data into multiple groups. Each group associated with a subset of data is referred to as a binding. In some embodiments, data mining engine 304 may create the bindings at different stages (e.g., three stages) by filtering out more data at each stage. Data mining engine 304 may transmit the final bindings to a corresponding module of data server 120 (e.g., matching engine 306) for purpose of matching.

Data mining engine 304 may create the bindings or groups based on one or more attributes. An attribute or identifier may be a vendor number, a location/store number, etc. In some embodiments, data mining engine 304 may take a common variable of the invoice and receipt as an identifier to create the bindings.

In some embodiments, the binding creation includes three stages. At the first stage, data mining engine 304 may create the first bindings based on a first set of attributes. For example, the first set of attributes may include a “vendor number” attribute and a “location number” attribute. Data mining engine 304 generates unique combinations of “vendor number” and “location number,” and fetches the invoice and receipt data having the unique combinations. As a result, the entire invoice and receipt data is divided into smaller groups or chunks. Each group or chunk is a binding that includes the invoices and receipts having a particular vendor number and a particular location number.

At the second stage, data mining engine 304 may further filter the first bindings based on a second set of attributes. In some embodiments, the second set of attributes may include the invoice ID corresponding to the particular vendor number and location number. Data mining engine 304 may identify a particular invoice with the invoice ID, and all the receipt(s) associated with that particular invoice. In some embodiments, data mining engine 304 may implement the filtration of possible receipts through a series of logic built around certain invoice and receipt attributes. These attributes for filtering the receipts may be one or more of the invoice date, receipt date, total cost amount of the invoice and/or the receipt, etc.

Using different attributes, data mining engine 304 may create different filters to obtain the receipt(s) associated with the particular invoice. For example, data mining engine 304 may determine a first filter based on the attribute of “receipt date,” which requires the receipt date must lie within invoice date ±x days, and x is a user-defined threshold. If x=10, then the first filter is configured as:
Invoice Date−10 days<Receipt Date<Invoice Date+10 days

The first filter allows the receipts to be filtered based on the temporal relationship between the receipts and the invoice. It should be noted that the threshold of each filter is configurable. In some embodiments, each threshold may be changed based on user feedback, market needs, and/or other factors. For example, the 10-day threshold may be increased to accommodate a shipment delay.

Data mining engine 304 may use a second filter based on “receipt cost” to further refine the relevant receipts. For example, the second filter requires the total receipt cost amount must be less than (100+x) % of the invoice total cost amount, where x is a user-defined threshold. Suppose x=10, the second filter may be:
Receipt Total Cost Amount Invoice Total Cost Amount×(1+0.10)

Using both the first and second filters, data mining engine 304 retrieves the receipts that (1) fall within a 10-day window of a particular invoice and (2) have a cost discrepancy within 10% from the particular invoice. That is, second bindings are created to associate the receipts to a particular invoice in view of certain criteria. In some embodiments, a combination of vendor number, location number, invoice ID, and all the receipt IDs of the relevant/associated receipts is referred to as a second binding. Particularly, since the receipt IDs are obtained, the line-level data may be extracted and filtered for the purpose of matching.

One challenge in matching invoices and receipts is to address one-to-many relationships such as when one invoice is associated with multiple receipts. For example, when the shipment for a particular invoice is received in parts, this single invoice is divided into two or more receipts. Currently, there is no efficient way to handle the one-to-many relationships between the invoices and receipts. Further, the existing matching algorithms usually perform data matching based on summary information of invoices/receipts. These algorithms, therefore, do not take the line level relationship into account when matching the invoices and receipts. Consequently, these algorithms tend to produce false results (e.g., false claims and/or exceptions) when the numbers of line items on an invoice and a receipt are different, for example, when one invoice line item (e.g., product) is split to multiple receipt line items, or when one receipt line item corresponds to multiple invoice items.

Creating third bindings at the third stage is a part of the present disclosure addressing the specific situation of one-to-many relationships and/or line-level relationships. Data mining engine 304 may determine multiple combinations (e.g., three combinations) of the relevant receipts and treat each of these combinations as a single receipt for a given invoice. Data mining engine 304 may then perform one or more check functions to verify whether a combined receipt is good enough to be treated as a possible match for the invoice. It should be noted that the receipt can either be a combined receipt (one-to-many relationship) or can be a single receipt (one-to-one relationship).

In some embodiments, data mining engine 304 may perform a cost check (e.g., check-1) and a line item check (e.g., check-2) as listed below.

Check-1: Absolute percent deviation of the “Combined Receipt Total Cost Amount” and the “Invoice Total Cost Amount” must be less than or equal to x %. Here, x is a user-defined threshold, e.g., x=75.

$$\vert \frac{( C o m bined Receipt Total Cost Amount - Invoice Total Cost Amount )}{Invoice Total Cost Amount} \vert \leq 0.75$$

Check-2: Absolute percent deviation of the “Combined Receipt Line Items” and the “Invoice Line Items” must be less than x %. Here, x is a user-defined threshold, e.g., x=75.

$$\vert \frac{( C o m bined Receipt Line Items - Invoice Line Items )}{Invoice Line Items} \vert \leq 0.75$$

It should be noted that each threshold used in the check functions is configurable, which may be modified based on user feedback, market needs, and/or other factors. In some embodiments, data mining engine 304 may identify all the combined receipts that pass through all the checks, and construct third binding(s) based on the vendor number, location/store number, total amount, number of lines in invoice and receipt or a combination of receipts. The third binding(s) is the final form of binding, which is used as input to matching engine 306 for performing the line-level matching as described below.

### Matching Algorithm

Each of the final bindings (e.g., third bindings) has its own chunk of invoice data and receipt data, from which certain major attributes/variables may be selected and used in a matching algorithm. In some embodiments, upon receiving the final bindings, matching engine 306 performs line-level matching between the invoices and receipts using the matching algorithm based on the selected one or more attributes/variables. For example, the line-level attribute may be an item number, item description, quantity, price, etc. Based on comparing the line-level attributes from both the invoices and receipts, matching engine 306 may generate one or more line-level matches.

### Line-Level Matching

To perform line-level matching, matching engine 306 compares all the line items or products in an invoice with all the line items in a receipt. In some embodiments, matching engine 306 may pair the line items of each invoice and receipt. Matching engine 306 may compare different line-level attributes between each pair of line items by calculating different distance metrics. Matching engine 306 may determine a respective score based on each distance metrics, and then combine the scores (e.g., based on weights) to generate an aggregated score. The aggregated score above a pre-defined threshold may reflect the presence of a line-level match. In some embodiments, matching engine 306 may configure and adjust each weight based on the training of one or more AI/ML models, which will be described in detail below with reference to ML engine 312.

In a typical example, matching engine 306 may select “item number” and “item description” as the line-level attributes used for the comparison between each pair of line items, the pair of line items including one from the invoice and one from the receipt. Matching engine 306 may compare the “item number” using a Levenshtein distance and compare the “item description” using a Jaro-Winkler distance. Both of these distance metrics are used for the comparison of strings. Based on comparing each element of the strings using a distance metric, matching engine 306 may determine a score for each distance metric and aggregate the scores to determine whether a line-level match exists.

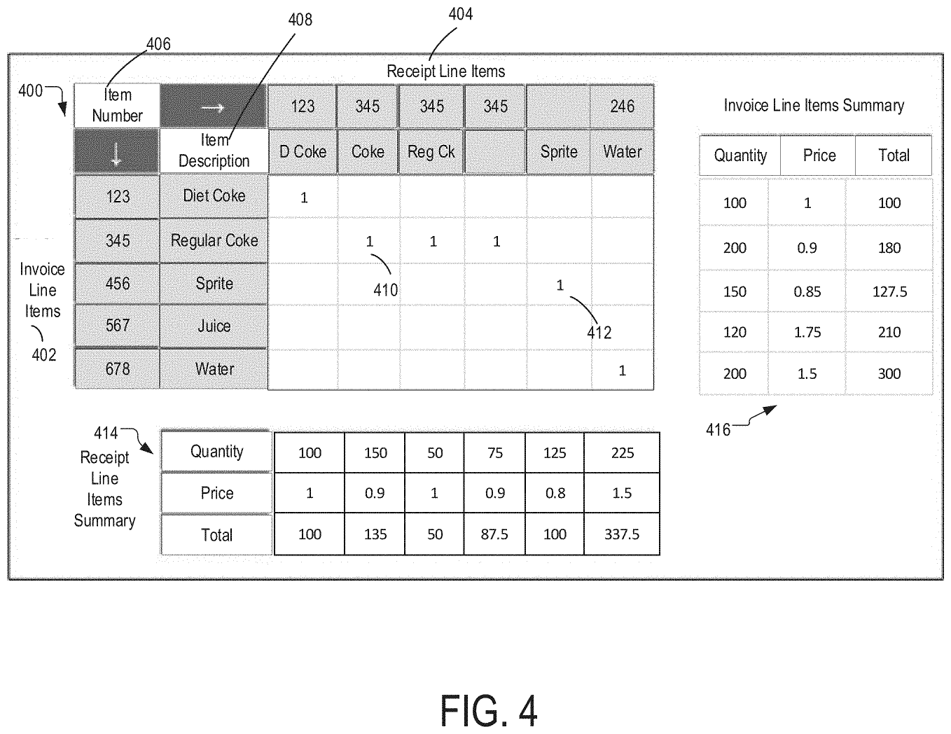

FIG. 4 are example tables 402, 414, 416 illustrating line-level matching of invoice and receipt. In some embodiments, matching engine 306 may communicate with a user interface engine (not shown) to generate and present tables 402, 414, 416 on a user interface of user device 106. As depicted in the match matrix of table 400, matching engine 306 first pairs all the line items from invoice 402 and receipt 404. If there are M line items in the invoice and N line items in the receipt, matching engine 306 may determine the M×N number of pairs, on which the distance metrics will be calculated.

In the example of FIG. 4, the selected line-level attributes used for comparison are item number 406 and item description 408. For item number 406, matching engine 306 may calculate a Levenshtein distance between a pair of item numbers and generate a scaled score. If the scaled score exceeds a pre-defined threshold, matching engine 306 may determine a match between the pair of item numbers. A flag “1” may be used to indicate only a match of the item number (not item description), while a flag “0” may be used to indicate a non-match of the item number.

Similarly, for item description 408, matching engine 306 may calculate a Jaro-Winkler distance between a pair of item descriptions and generate a scaled score. If the scaled score exceeds a pre-defined threshold, matching engine 306 may determine there is a match between the pair of item descriptions. A flag “1” may be used to indicate only a match of the item description (not item number), while a flag “0” may be used to indicate a non-match of the item description.

Once the different scores based on the comparison of item number 406 and item description 408 are determined, matching engine 306 may take a weighted sum of the scores to generate an aggregate score. The weights may be determined and adjusted based on one or more AI/ML models. If the aggregated score exceeds a pre-defined threshold, matching engine 306 determines that the pair of line items have a match. Matching engine 306 may communicate with a user interface engine (not shown) to update the table with a flag. For example, a flag “1” may be placed along with the particular pair of items to indicate a match at line level. In table 400, the flags at 410 and 412 may show a respective match for a respective pair of line items. As shown in table 400, there are a total number of six “1” flags, which indicates that six line-level matches are found. Also, the absence of a flag in the line of “juice” indicates that no match is found for the line item “juice.”

It should be noted that, a flag “1” in table 400, such as 410 and 412, represents a match of the pair of line items on one or more selected line-level attributes instead of on every attribute of the invoice and receipt data. In addition, this match may not be an exact match (e.g., 100% match) with respect to the one or more selected line-level attributes. For example, matching engine 306 may determine “regular Coke” in the invoice matches “reg ck” in the receipt. As described below, the goodness or value of a match (e.g., a match percentage) may be determined.

It should also be noted that one line item from the invoice may have multiple matching line items from the receipt, and vice versa. In some embodiments, matching engine 306 may perform a group-by operation to obtain all the matching receipt line items corresponding to each invoice line item, which will be used in the calculation of claims. In some embodiments, matching engine 306 may merge all the matched receipt line items corresponding to each unique invoice item number, and aggregate the prices and quantities, for example, as shown in tables 414 and 416.

### Claim Calculation

Referring back to FIG. 3, in response to receiving an output of line-level matching between the invoice and receipt data from matching engine 306, claim generator 308 is initiated to calculate one or more claims. In some embodiments, claim generator 308 may identify claim attributes (e.g., price attribute, quantity attribute), and calculate a claim based on the identified attributes of both the matched line items and unmatched line items from the invoice and receipt data. In some embodiments, claim generator 308 may generate three types of claims: price claim, quantity claim, and line claim. Regardless of the claim types, claim generator 308 may generate the claims in a single unit, e.g., in dollar values, to facilitate the further calculation of match percentages.

In some embodiments, claim generator 308 may first generate a price claim at the line level for every matched invoice item number. Claim generator 308 generates this line-level price claim by calculating an absolute difference between the aggregated invoice item price and aggregated receipt item price, multiplied by the aggregated invoice item quantity.
Price Claim=|(Aggr. Invoice Price−Aggr. Receipt Price)|×(Aggr. Invoice Quantity)

Claim generator 308 may then generate a total price claim for a combination of an invoice and one/multiple receipts. Claim generator 308 generates this total price claim by summing over all the line-level price claims, corresponding to the matched line items.

In some embodiments, claim generator 308 also generates quantity claims. Claim generator 308 may first generate a quantity claim at the line level for every matched invoice item number. Claim generator 308 generates this line-level quantity claim by calculating an absolute difference between the aggregated invoice item quantity and aggregated receipt item quantity, multiplied by the aggregated invoice item price.
Quantity Claim=|(Aggr. Invoice Quantity−Aggr. Receipt Quantity)|×(Aggr. Invoice Price)

Claim generator 308 may then generate a total quantity claim for a combination of an invoice and one/multiple receipts. Claim generator 308 generates this total quantity claim by summing over all the line-level quantity claims, corresponding to the matched line items.

In some embodiments, claim generator 308 further generates line claims. Claim generator 308 may first generate a line claim at the line level for every unmatched invoice item number as well as the receipt item number. Claim generator 308 generates this line-level line claim by multiplying the aggregated invoice/receipt item quantity and the aggregated invoice/receipt item price.
Line Claim=(Aggr. Invoice/Receipt Quantity)×(Aggr. Invoice/Receipt Price)

Claim generator 308 may then generate a total line claim for a combination of an invoice and one/multiple receipts. Claim generator 308 generates this total line claim by summing over all the line-level line claims, corresponding to the unmatched line items.

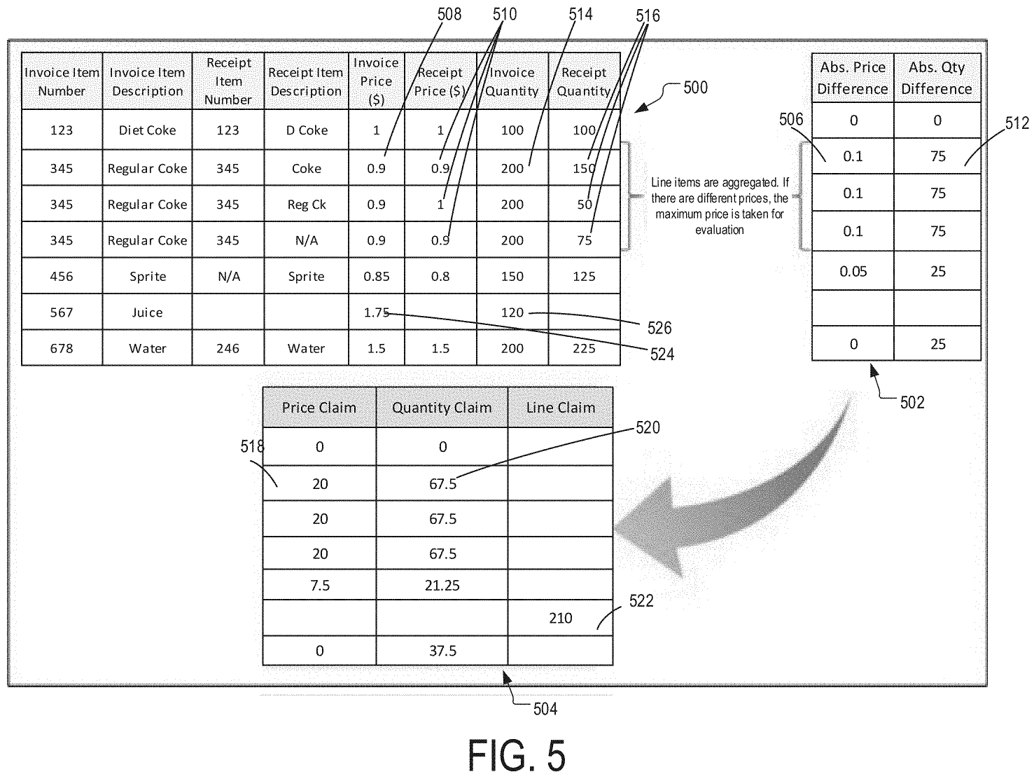

FIG. 5 is an example process for calculating claims responsive to line-level matching performed as shown in FIG. 4. Table 500 lists the line items with various attributes. Table 502 lists the absolute price difference and absolute quantity difference for each pair of line items. Table 504 lists three types of claims calculated by claim generator 308.

Table 502 is derived from table 500. For example, claim generator 308 calculates the absolute price difference 0.1 at 506 based on the invoice price 0.9 at 508 and the receipt prices at 510. In some embodiments, when aggregating the line items, claim generator 308 may take the maximum price for evaluation if there are different invoice prices or different receipt prices. Claim generator 308 takes the maximum (i.e., 1) of the receipt prices 1 and 0.9 at 510, and obtains a price difference 0.1 at 506 with the invoice price 0.9 at 508. Claim generator 308 also calculates the absolute quantity difference. For example, claim generator 308 determines the absolute quantity difference 75 at 512 based on the invoice quantity 200 at 514 and the receipt quantity at 516, which is the absolute value of 200−(150+50+75).

As shown in table 400 of FIG. 4, a total number of six “1” flags indicates that six line-level matches are found, and the flag absence indicates that no match is found for the line item “juice.” In response, as shown in table 504, claim generator 308 calculates price claims and quantity claims for six matched line items, and calculates a line claim for the unmatched line time “juice.” For example, claim generator 308 determines price claim 518 based on the absolute price difference 0.1 at 506 and the aggregated invoice quantity 200 at 514, i.e., 0.1×200=20. Claim generator 308 may also determine quantity claim 520 based on the absolute quantity difference 75 at 512 and the aggregated invoice price 0.9 at 508, i.e., 75×0.9=67.5. Further, claim generator 308 may determine line claim 522 for the unmatched line item “juice.” Since the receipt price and/or quantity is missing, claim generator 308 determines this claim based on invoice price 1.75 at 524 and invoice quantity 120 at 526, i.e., 1.75×120=210.

### Match Percentages

Referring again back to FIG. 3, in response to receiving the line-level matching information from matching engine 306 and claim information from claim generator 308, recommendation module 310 may evaluate the value/goodness of a match and generate a match recommendation. To measure a level of match or the goodness of the match between an invoice and a combination of receipts, in some embodiments, recommendation module 310 may use two match percentage metrics. Both of the metrics may provide information about how close the combination of receipts is to the invoice in terms of the possible claim amounts and/or the number of line items that have been matched. The higher the match percentage, the better the match.

In order to quantify the goodness of the match for a pair of invoice and receipt with respect to possible claim amounts that may be generated for the pair, recommendation module 310 may calculate a first match percentage, e.g., Match Percent−1.

$$Match Percent 1 = [ 1 \{ \frac{( T otal Price Claim + Total Quantity Claim + Total Line Claim )}{( Total Invoice Cost Amount + Total Receipt Cost Amount )} \} ] \times 100$$

Recommendation module 310 first determines a ratio of the sum of all the possible claim amounts with the sum of the total invoice and receipt cost amount. The closer the fraction is to one, the poorer the match is. Recommendation module 310 then subtracts this ratio from one to obtain Match Percent−1, which indicates how close the receipt is to the invoice.

In order to quantify the goodness of the match for a pair of invoice and receipt in terms of the actual number of line items that have been matched, recommendation module 310 may calculate a second match percentage: Match Percent−2.

$$Match Percent 2 = \{ \frac{( Number of Invoice Lines Matched + N umber of Receipt Lines Matched )}{( Total Number of Invoice Lines + Total Number of Receipt Lines )} \} \times 100$$

Recommendation module 310 determines Match Percent−2 to be the ratio of the sum of the number of lines from invoice and receipt that have been matched with the sum of the total number of invoice and receipt line items. The closer the fraction is to 1, the better the match.

Multiple custom calculations such as line-level matching and claim generation are performed, e.g., by matching engine 306 and claim generator 308, to determine the deviation between a given invoice product line item and receipt product line item, which are finally aggregated at total invoice and total receipt level, e.g., by claim generator 308 and recommendation module 310. In other words, after the deviation between the invoice and receipt data is quantified based on the mismatches in product line description, price, quantity and/or other attributes, recommendation module 310 generates a recommendation of the best match based on the normalized value of absolute quantified deviation and match percentage(s). In some embodiments, recommendation module 310 may compare the match percentages for different pairs of invoices and combinations of receipts, and determine the best matching pair, e.g., the pair of invoice and receipt with a highest matching percentage. In some embodiments, recommendation module 310 may assign a priority to any of the two match percentages according to user/customer needs. Recommendation module 310 provides a match recommendation to a user/customer.

Model Building based on Feedback Mechanism

ML engine 312 builds and implements one or more AI/ML models (e.g., supervised ML models) to improve the matching algorithm in generating recommended match(es) between the invoice and receipt data. In particular, the one or more ML models may be used to improve the line-level matching of an invoice and a receipt, that is, increasing match percentages.

In some embodiments, ML engine 312 uses both data received/generated from the invoices and receipts and user feedback data to train the one or more ML models. ML engine 312 may continuously collect the new data generated in processing the invoices and receipts and use the newly collected data to retrain the ML models to improve the matching performance. For example, the new data may include a recommended match, user feedback to the recommended match, previously calculated distance metrics, etc.

In some embodiments, ML engine 312 communicates with a feedback mechanism. Upon receiving a recommended match, a user may verify the recommended match by flagging each pair of matched line items. For example, flag=1 may represent that the user confirms the match, and the match is correct, while flag=0 may be an indicator of an incorrect recommended match. ML engine 312 may then use the flag variables as one type of label to build and train the ML models.

To build and implement the one or more AI/ML models, ML engine 312 may utilize the labels as dependent variables and generate feature variables from the line-level data (of invoices and receipts). In some embodiments, ML engine 312 may specify certain attributes of the invoice and receipt data used in the AI/ML models. Typical attributes that help modeling may include the item number, item description, quantity, individual cost amount, total cost amount, invoice date, receipt date, etc. ML engine 312 may generate feature variables for the ML models by performing mathematical operations on the specified attributes. For example, ML engine 312 may use some key features listed below to build the model training:
1. Levenshtein distance between invoice and receipt “item number”;
2. Jaro-Winkler distance between invoice and receipt “item number”;
3. Levenshtein distance between invoice and receipt “item description”;
4. Jaro-Winkler distance between invoice and receipt “item description”;
5. Difference between invoice and receipt “quantity”;
6. Difference between invoice and receipt “each cost amount”;
7. Difference between invoice and receipt “total cost amount”;
8. Difference between “invoice date” and “receipt date.”

In some embodiments, ML engine 312 may use the above eight features generated from the invoice data and receipt data to build different ML models (e.g., different supervised classification models). ML engine 312 may also scale the newly generated data using a min-max scaler function listed below to make sure the new data is suitable for training the models.

$${X}_{s c a l e d} = \frac{X - {X}_{min}}{{X}_{max} - {X}_{min}}$$

Responsive to the feature variables being created or built, ML engine 312 starts modeling based on the newly generated data, where the flag variable obtained from the user feedback is taken as a target variable. In some embodiments, based on the generated features, ML engine 312 trains the models to solve a binary classification problem, that is, determining whether a line item from a receipt is a good match for a line item in an invoice. In some embodiments, ML engine 312 may choose from different algorithms such as random forest classifier, logistic regression, or support vector machine to build, train, and implement multiple models.

In some embodiments, ML engine 312 may determine and adjust model parameters to reduce errors and robustize the models. Further, based on feature importance metrics and graphs, ML engine 312 may add, remove, or change the feature variable(s) according to specific needs. For example, based on different feedback, ML engine 312 may generate and adjust different weights used in line-level matching, claim calculation, and other related tasks to reduce the discrepancy between the pair of invoice and receipt that is recommended and actually used. ML engine 312 may also change the weights for different line items over time based on user feedback or other newly generated data. When an appropriate model is determined, ML engine 312 may store this model and associated model parameters in a file (e.g., a Python pickle file) in data store 124, which allows the model to be easily used in the production level data for further testing and retraining.

In some embodiments, before implementing the models on real-time data, ML engine 312 may pre-process the data. Similar to creating bindings performed in an initial phase of the matching process, ML engine 312 may also divide the received data into smaller chunks or groups of data. After passing through a variety of filters and checks as discussed above, ML engine 312 may obtain final chunks. Each of the final chunks of the data may include an invoice, the relevant receipt(s), and all possible pair-wise combinations of the line items present in the invoice and receipt(s). ML engine 312 may then create the feature variables corresponding to each pair-wise combination, and feed the feature variables into the models.

From the pickle file saved during model training, ML engine 312 may load the model weights, continuously collect new data (e.g., user feedback), and update and retrain the models based on the new data. In some embodiments, based on the training and implementation of the models, a binary output is generated, that is, “0” if a pair of line items is not a match and “1” if a pair of line items are a match. Once the model outputs are generated, that is, the line-level match is determined, the rest of the procedures remain the same. For example, one line item from the invoice may have multiple matching line items from the receipt and vice versa. When a group-by operation is performed, all the matching receipt line items corresponding to each invoice line item are obtained for the calculation of claims. Thus, all the matched receipt line items corresponding to each unique invoice line item are merged and all the prices and quantities are aggregated. The three types of claims are calculated, and the goodness of a match is determined using the match percentages.

In some embodiments, ML engine 312 may also use the one or more ML models to resolve the product name conflict. A knowledge graph captures different representations of different stock keeping unit (SKU) identifiers, product descriptions, and unit of measure (UOM) by the vendors across invoices and receipts. Based on the ML models, ML engine 312 may create and regularly update a knowledge graph to capture the different possible representations of SKU and product descriptions by the vendors that may be leveraged for a different retailer.

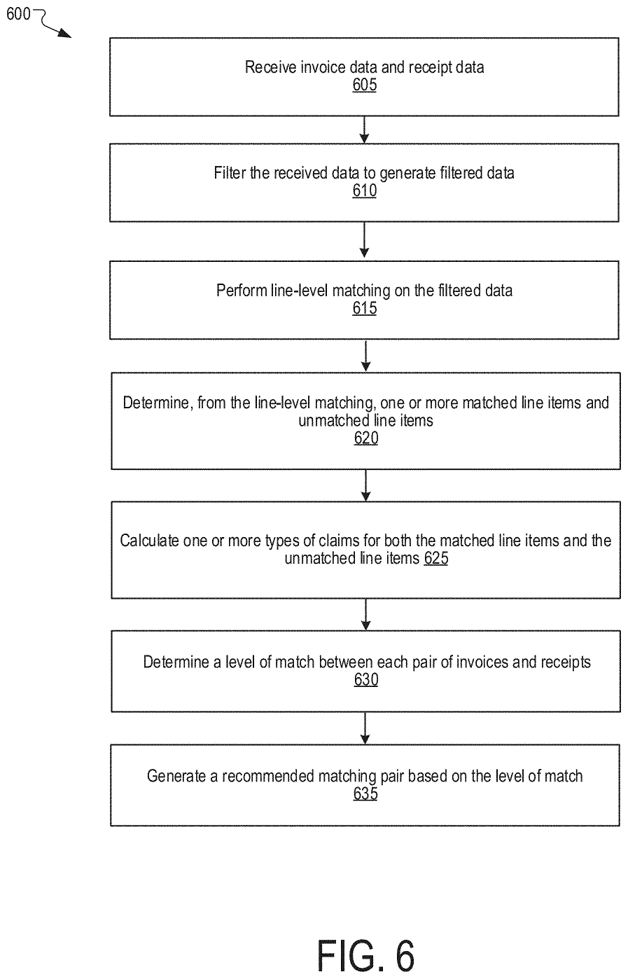

FIG. 6 illustrates a flowchart 600 of detecting and managing deviation between an invoice and a receipt, according to embodiments of the disclosure. In some embodiments, exception management application 122 of data server 120 as depicted in FIG. 1 in communication with other components of system 100 to implement process 600. At step 605, exception management application 122 receives invoice data and receipt data, for example, from user device 104 or external server 110. At step 610, exception management application 122 filters the received data to generate filtered data based on multi-stage binding creation. In some embodiments, exception management application 122 may first pre-process the received invoice and receipt data, e.g., parsing the data or performing OCR and custom NER on the data, to convert the received data into structured data, and then obtain the processed data by grouping the received data in small chunks based on specific attributes.

At step 615, exception management application 122 performs line-level matching on the filtered data based on one or more line-level attributes and one or more distance based algorithms.

At step 620, exception management application 122 determines, from the line-level matching, one or more matched line items and unmatched line items between each pair of the invoices and receipts included in the filtered data. For example, exception management application 122 may select “item number” and “item description” as the line-level attributes used for the comparison between each pair of line items, the pair of line items including one from the invoice and one from the receipt. Exception management application 122 may compare the “item number” using a Levenshtein distance and compare the “item description” using a Jaro-Winkler distance. Based on comparing each element of the strings using a distance metric, exception management application 122 may determine a distance score for each distance metric and aggregate the scores to determine whether a line-level match exists.

At step 625, exception management application 122 calculates one or more types of claims for both the matched line items and the unmatched line items to measure a total deviation between each pair of the invoices and receipts. In some embodiments, the one or more types of claims include a price claim, a quantity claim, or a line claim. Exception management application 122 may calculate a type of claim by generating a number of the type of line-level claims, and summing up the number of the type of line-level claims corresponding to the matched line items or the unmatched line items.

At step 630, exception management application 122 determines a level of match between each pair of the invoices and receipts based on the calculated claims, for example, generating, based at least on the calculated claims, one or more match percentages to indicate the level of match between the invoice and the receipt. At step 635, exception management application 122 generates a recommended matching pair of invoice and receipt based on the level of match between each pair of the invoices and receipts. For example, exception management application 122 may compare the match percentages for different pairs of invoices and combinations of receipts, and determine the best matching pair, e.g., the pair of invoice and receipt with a highest matching percentage. In some embodiments, exception management application 122 may also receive user reaction to the recommended matching pair, retrain the one or more ML models using the user feedback, and refine at least the line-level matching and the recommended matching pair based on retraining the one or more ML models.

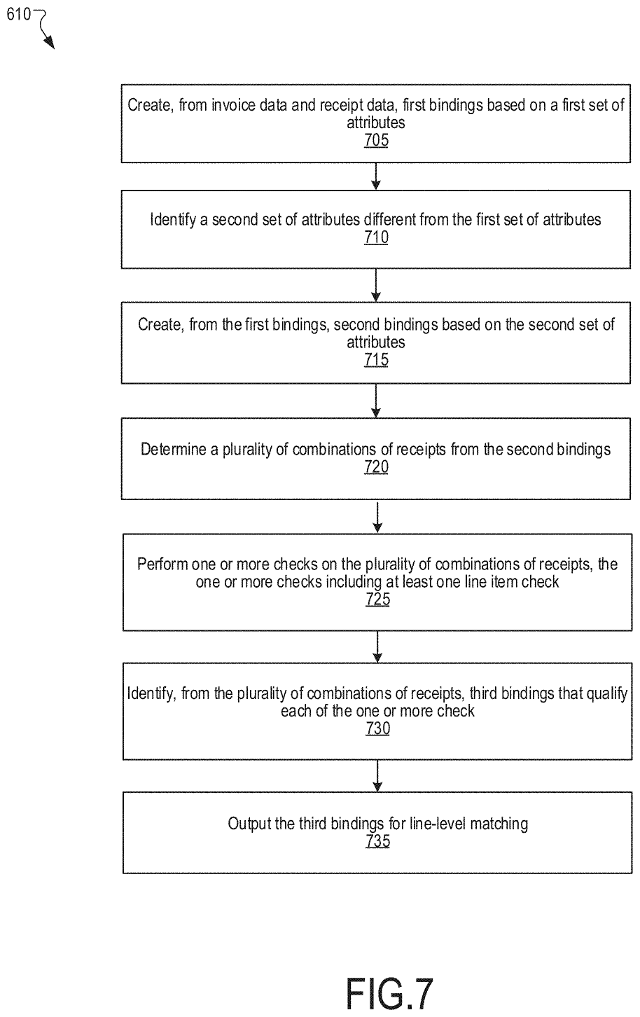

FIG. 7 illustrates a flowchart of creating binding from invoice and receipt data, according to embodiments of the disclosure. In some embodiments, this flowchart corresponds to step 610 of FIG. 6. In some embodiments, exception management application 122 of data server 120 as depicted in FIG. 1 communicates with other components of system 100 to implement process 610. In this process, exception management application 122 performs multi-stage binding creation based on sorting and dividing the pre-processed data into multiple bindings. Each binding includes a subset of the received invoice and receipt data.

Upon receiving invoice data and receipt data, at step 705, exception management application 122 creates first bindings based on a first set of attributes. For example, the first set of attributes may include a “vendor number” attribute and a “location number” attribute. Exception management application 122 generates unique combinations of “vendor number” and “location number,” and fetches the invoice and receipt data having the unique combinations.

At step 710, exception management application 122 identifies a second set of attributes different from the first set of attributes. At step 715, exception management application 122 creates, from the first bindings, second bindings based on the second set of attributes. For example, the second set of attributes may include the invoice ID corresponding to the particular vendor number and location number. Exception management application 122 may identify a particular invoice with the invoice ID, and all the receipt(s) associated with that particular invoice.

At step 720, exception management application 122 determines a plurality of combinations of receipts from the second bindings. At step 725, exception management application 122 performs one or more checks on the plurality of combinations of receipts, the one or more checks including at least one line item check. Exception management application 122 may determine multiple combinations (e.g., three combinations) of the relevant receipts and treat each of these combinations as a single receipt for a given invoice. Exception management application 122 may then perform one or more check functions to verify whether a combined receipt is good enough to be treated as a possible match for the invoice. In some embodiments, the one or more checks include at least a cost check and a line item check.

At step 730, exception management application 122 identifies, from the plurality of combinations of receipts, third bindings that qualify each of the one or more checks. At step 735, exception management application 122 then outputs the third bindings to other components of data server 120 for line-level matching. In some embodiments, exception management application 122 may identify all the combined receipts that pass through all the checks, and construct third binding(s) based on the vendor number, location number, invoice ID, and single/combined receipt ID of the identified receipts.

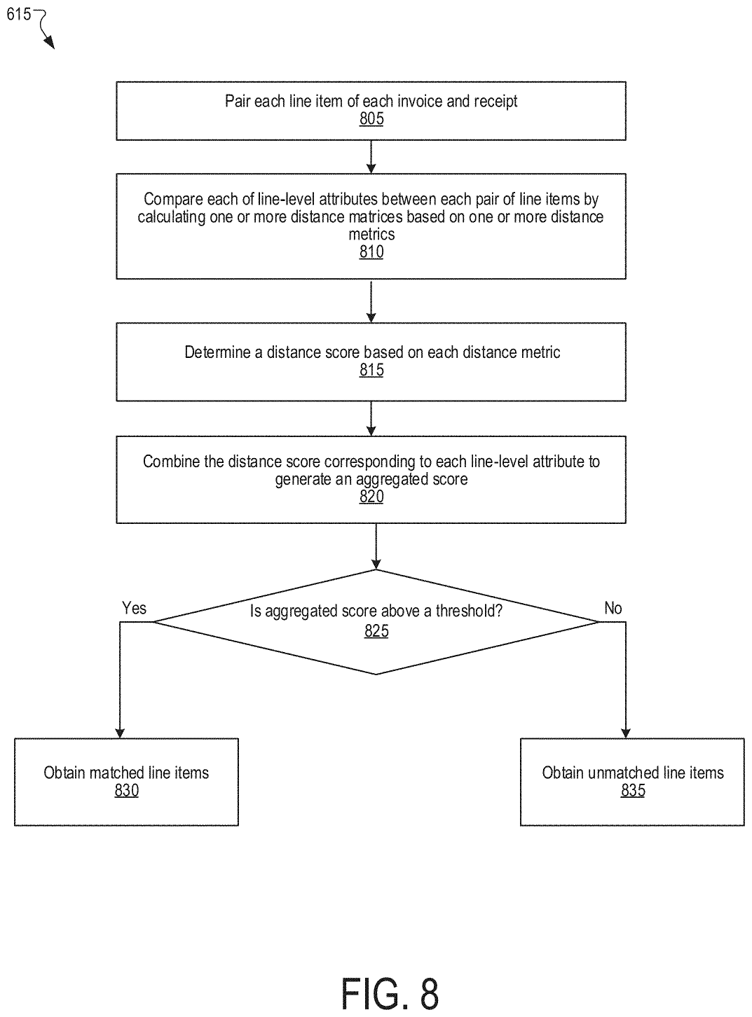

FIG. 8 illustrates a flowchart of line-level matching between invoice and receipt data, according to embodiments of the disclosure. In some embodiments, this flowchart corresponds to step 615 of FIG. 6. In some embodiments, exception management application 122 of data server 120 as depicted in FIG. 1 communicates with other components of system 100 to implement process 615.

At step 805, exception management application 122 pairs each line item of each invoice and receipt. At step 810, exception management application 122 compares each of line-level attributes between each pair of line items by calculating one or more distance metrics. The one or more distance metrics are updated based on the user feedback fed into the one or more ML models. At step 815, exception management application 122 determines a distance score based on each distance metric. At step 820, exception management application 122 combines the distance score corresponding to each line-level attribute to generate an aggregated score. At step 825, exception management application 122 determines whether the aggregated score exceeds a pre-defined threshold. If the aggregated score is above the pre-defined threshold, at step 830, exception management application 122 determines a line-level match of the invoice and the receipt, e.g., matched line items. If the aggregated score does not exceed the pre-defined threshold, at step 835, exception management application 122 determines unmatched line items. The matched and unmatched line items are then processed to determine different types of claims. In some embodiments, the line-level matching is used to determine the deviation between a given invoice product line and a receipt product line, while claims are aggregated to measure the deviation at a total invoice level and/or total receipt level.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated and described with the figures above. Modules may constitute either software modules (e.g., code embodied on a machine-readable medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processors) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” is employed to describe elements and components of the embodiments herein. This is done merely for convenience and to give a general sense of the claimed invention. This description should be read to include one or at least one and the singular also includes the plural unless it is obvious that it is meant otherwise.

Upon reading this disclosure, those of skill in the art will appreciate still additional alternative structural and functional designs for the system described above. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for detecting deviation between invoices and receipts, the method comprising:
receiving data of the invoices and receipts;
filtering the received invoice and receipt data to generate filtered data;
performing line-level matching on the filtered data based on one or more line-level attributes and one or more distance based algorithms to identify line item matches between the invoices and receipts;
determining, from the line-level matching, one or more matched line items and unmatched line items between each pair of the invoices and receipts included in the filtered data;
calculating one or more types of claims for both the matched line items and the unmatched line items to measure a total deviation between each pair of the invoices and receipts;
determining a level of match between each pair of the invoices and receipts based on the calculated claims; and
generating a recommended matching pair of invoice and receipt based on the level of match between each pair of the invoices and receipts.

2. The method of claim 1, wherein a many-to-many line level relationship, including a single line of an invoice being associated with multiple lines of a receipt, is detected and determined based on one or more operations of filtering the received invoice and receipt data, performing the line-level matching, determining the one or more matched line items and unmatched line items, calculating the one or more types of claims, determining the level of match, or generating the recommended matching pair.

3. The method of claim 1, wherein a one-to-many relationship, including a single invoice being associated with multiple receipts, is detected and determined based on one or more operations of filtering the received invoice and receipt data, performing the line-level matching, determining the one or more matched line items and unmatched line items, calculating the one or more types of claims, determining the level of match, or generating the recommended matching pair.

4. The method of claim 1, wherein prior to filtering the received invoice and receipt data to generate the filtered data, further comprising:
determining whether the received data is in an electronic data interchange (EDI) format;
responsive to determining whether the received data is in an EDI format, identifying one or more operations to pre-process the received data; and
pre-processing the received data using the one or more operations.

5. The method of claim 4, wherein filtering the received invoice and receipt data comprises performing multi-stage binding creation by sorting and dividing the pre-processed data into multiple bindings, each binding including a subset of the received invoice and receipt data.

6. The method of claim 5, wherein sorting and dividing the pre-processed data comprises:
creating, from the received invoice and receipt data, first bindings based on a first set of attributes;
identifying a second set of attributes different from the first set of attributes;
creating, from the first bindings, second bindings based on the second set of attributes;
determining a plurality of combinations of receipts from the second bindings;
performing one or more checks on the plurality of combinations of receipts, the one or more checks including at least one line item check;
identifying, from the plurality of combinations of receipts, third bindings that qualify each of the one or more checks; and
outputting the third bindings as the filtered data.

7. The method of claim 1, further comprising:
responsive to generating the recommended matching pair, receiving user feedback about the recommended matching pair;
specifying a set of attributes of the received invoice and receipt data for the recommended matching pair; and
training one or more machine learning (ML) models to identify matching pairs of invoices and receipts by providing the user feedback as input to the one or more ML models.

8. The method of claim 7, wherein the line-level matching further comprises:
pairing each line item of each invoice and receipt included in the filtered data;
comparing each of the one or more line-level attributes between each pair of line items by calculating one or more distance metrics, wherein the one or more distance metrics are updated based on the user feedback provided as input to the one or more ML models;
determining a distance score based on each distance metric;
combining the distance score corresponding to each line-level attribute to generate an aggregated score; and
determining a line-level match of the invoice and the receipt responsive to the aggregated score exceeding a pre-defined threshold.

9. The method of claim 8, wherein the distance score corresponding to each line-level attribute is combined based on a weight associated with each line-level attribute, and the weight is adjustable based on training the one or more ML models using the user feedback.

10. The method of claim 1, wherein the one or more line-level attributes comprise at least one of an item number and an item description.

11. The method of claim 1, wherein the one or more types of claims include a price claim, a quantity claim, or a line claim, and wherein calculating a type of claim comprises:
generating a number of the type of line-level claims; and
summing up the number of the type of line-level claims corresponding to the matched line items or the unmatched line items.

12. The method of claim 1, wherein determining the level of match comprises:
generating, based at least on the calculated claims, one or more match percentages to indicate the level of match between the invoice and the receipt.

13. A system for detecting deviation between invoices and receipts, the system comprising:
a processor; and
a memory in communication with the processor and comprising instructions which, when executed by the processor, program the processor to:
receive data of the invoices and receipts;
filter the received invoice and receipt data to generate filtered data;
perform line-level matching on the filtered data based on one or more line-level attributes and one or more distance based algorithms to identify line item matches between the invoices and receipts;
determine, from the line-level matching, one or more matched line items and unmatched line items between each pair of the invoices and receipts included in the filtered data;
calculate one or more types of claims for both the matched line items and the unmatched line items to measure a total deviation between each pair of the invoices and receipts;
determine a level of match between each pair of the invoices and receipts based on the calculated claims; and
generate a recommended matching pair of invoice and receipt based on the level of match between each pair of the invoices and receipts.

14. The system of claim 13, wherein, prior to filtering the received data to generate filtered data, the instructions further program the processor to:
determine whether the received data is in an electronic data interchange (EDI) format;
responsive to determining whether the received data is in an EDI format, identify one or more operations to pre-process the received data; and
pre-process the received data using the one or more operations.

15. The system of claim 14, wherein, to filter the received invoice and receipt data, the instructions further program the processor to:
perform multi-stage binding creation by sorting and dividing the pre-processed data into multiple bindings, each binding including a subset of the received invoice and receipt data.

16. The system of claim 15, wherein, to sort and divide the pre-processed data into multiple bindings, the instructions further program the processor to:
create, from the received invoice and receipt data, first bindings based on a first set of attributes;
identify a second set of attributes different from the first set of attributes;
create, from the first bindings, second bindings based on the second set of attributes;
determine a plurality of combinations of receipts from the second bindings;
perform one or more checks on the plurality of combinations of receipts, the one or more checks including at least one line item check;
identify, from the plurality of combinations of receipts, third bindings that qualify each of the one or more checks; and
output the third bindings as the filtered data.

17. The system of claim 13, wherein the instructions further program the processor to:
receive user feedback about the recommended matching pair;
specify a set of attributes of the received invoice and receipt data for the recommended matching pair; and
train one or more ML models to identify matching pairs of invoices and receipts by providing the user as input to the one or more ML models.

18. The system of claim 17, wherein, to perform the line-level matching, the instructions further program the processor to:
pair each line item of each invoice and receipt included in the filtered data;
compare each of the one or more line-level attributes between each pair of line items by calculating one or more distance metrics, wherein the one or more distance metrics are updated based on the user feedback fed into the one or more ML models;
determine a distance score based on each distance metric;
combine the distance score corresponding to each line-level attribute to generate an aggregated score; and
determine a line-level match of the invoice and the receipt responsive to the aggregated score exceeding a pre-defined threshold.

19. The system of claim 13, wherein the one or more line-level attributes comprise at least one of an item number and an item description

20. A computer program product for detecting deviation between invoices and receipts, the computer program product comprising a non-transitory computer-readable medium having computer readable program code stored thereon, the computer readable program code configured to:
receive data of the invoices and receipts;
filter the received invoice and receipt data to generate filtered data;
perform line-level matching on the filtered data based on one or more line-level attributes and one or more distance based algorithms to identify line item matches between the invoices and receipts;
determine, from the line-level matching, one or more matched line items and unmatched line items between each pair of the invoices and receipts included in the filtered data;
calculate one or more types of claims for both the matched line items and the unmatched line items to measure a total deviation between each pair of the invoices and receipts;
determine a level of match between each pair of the invoices and receipts based on the calculated claims; and
generate a recommended matching pair of invoice and receipt based on the level of match between each pair of the invoices and receipts.
